(19) United States
(12) Patent Application Publication
(10) Pub. No.: US 2015/0294357 A1
(43) Pub. Date: Oct. 15, 2015

(54) PREFERENTIAL PLACEMENT OF PAID LISTINGS IN SEARCH ENGINE RESULTS

(71) Applicant: Zafir Anjum, Chico, CA (US)

(72) Inventor: Zafir Anjum, Chico, CA (US)

(21) Appl. No.: 14/679,011

(22) Filed: Apr. 5, 2015

Related U.S. Application Data
(60) Provisional application No. 61/978,744, filed on Apr. 11, 2014.

(51) Int. Cl. G06Q 30/02

(52) U.S. Cl. CPC G06Q 30/0256

(57) ABSTRACT

Embodiments of the claimed subject matter provide a method and system for preferential placement of paid listings in search engine results by sorting the results based on predominant criteria, an equivalence range for the predominant criteria, and subordinate criteria.

### CROSS-REFERENCE TO RELATED APPLICATION

This application claims priority and the benefit, under 35 U.S.C. §119(e), of U.S. Provisional Patent Application 61/978,744, filed Apr. 11, 2014.

### FIELD OF INVENTION

The present invention relates to search engine results and search engine marketing.

### BACKGROUND

Search engines have become the dominant method of finding information on the Internet. However, while search engine services have proved to be invaluable, the providers of such services have been continually trying to monetize their services without alienating their users. Such efforts at monetizing have resulted in the search results being less relevant. Paid inclusion which was once popular with search engine providers is no longer so.

Another way of monetizing search results, paid placement, is still popular today, albeit with the search engine providers and not necessarily with their users. Today they take the form of advertisements above, below and beside the main search listing. It is no surprise that users do not have much love for it. In fact, there are many extensions for web browsers such as AdBlock that remove these ads from the web page. There was another form of paid placement that is no longer in vogue today. In this form, the paid placement would result in the sponsored entries to be intermingled with the main results.

In the existing, basic model for paid placement search, an advertiser chooses one or more search terms that will trigger a search result that includes a hyperlink to the advertiser's web site. The search result is placed in a prominent position in the list of typically relevance-based results. If the searcher clicks on the link, a payment is made to the search service. This paid search model is known as pay-per-click. Payment is one of the primary criterion considered in determining placement of the paid result.

While it is understandable that a search engine provider would want to receive a return for their efforts in indexing search terms and results, arrangement of search results based solely on payment can lead to results that, for example, may not be relevant to the search and thereby cause the user to waste time and eventually abandon using the search engine.

Thus, a need exists for a way to improve search engine results over the basic paid placement model.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Organic search results are generated by search engines based on a series of metrics that determines their relevance to the searched term. These metrics are derived by algorithms and are generally based upon factors such as the content of a web-page, the trustworthiness of the website, and external factors such as back-links, social media, news, advertising, etc.

To overcome the shortcoming of paid placement as embodied in previous art, the claimed subject matter constrains the arrangement of the search results so that they are predominantly ordered by their relevance.

Recognizing that algorithmic determination of relevancy is based on indirect indicators of relevancy and further recognizing that some search queries may match millions of result items, it is assumed that many result items listed in response to a search query are perceivably the same in relevance. Therefore, rearranging items (listings) that are perceivably equi-relevant should not matter to the user of the search engine and the rearranged list should still appear relevant to the user.

The claimed subject matter is directed to preferential placement of paid listings. The claimed subject matter provides a method and system for ranking of items according to predominant criteria, then subordinate criteria within equivalent ranges of the predominant criteria.

One embodiment of the claimed subject matter is implemented as a method for preferential placement of sponsored item(s). One or more bids are received from one or more advertisers. Each bid is associated with an item, the sponsored item, in the search results. The sponsored item data, that includes the identity of the item being sponsored and the associated bid data, are saved in a data resource. A data resource is computer-readable media that is not a transitory, propagating signal. One or more search queries are received from one or more users and the results responsive to the queries are ordered by preferential ranking of sponsored items while retaining perceived ordering by relevance.

One embodiment of the claimed subject matter is implemented as a system for preferential placement of paid listing(s). A paid listing is an item being sponsored by an advertiser and has a bid associated with it. The system is implemented as a receptacle for receiving bids from advertisers and displaying the advertisers' paid listings with preferential placement. The receptacle may further comprise a data resource which stores the paid listings data which comprises of identifiers, bid data and other related data, and an advertising engine which processes the bids, and ranks the paid listings according to the relevancy and the bid amount.

Additional aspects and/or advantages will be set forth in part in the description which follows and, in part, will be apparent from the description, or may be learned by practice of the invention.

### BRIEF DESCRIPTION OF DRAWINGS

FIG. 1 illustrates an example environment in which the systems and methods discussed herein can be implemented.

FIG. 2 depicts a flowchart describing a process for bidding for preferential placement.

FIG. 3 depicts a flowchart describing a process for preferential placement of paid listings.

FIG. 4 depicts a flowchart describing another process for preferential placement of paid listings.

FIG. 5 is a high-level block diagram of apparatus that may be used to effect at least some of the various operations that may be performed in accordance with the present invention.

### DETAILED DESCRIPTION

Reference will now be made in detail to embodiments of the claimed subject matter, a method and system for advertiser monetization, examples of which are illustrated in the accompanying drawings. While the claimed subject matter will be described in conjunction with the embodiments, it will be understood that they are not intended to be limited to these embodiments. On the contrary, the claimed subject matter is intended to cover alternatives, modifications and equivalents, which may be included within the spirit and scope as defined by the appended claims.

Furthermore, in the following detailed descriptions of embodiments of the claimed subject matter, numerous specific details are set forth in order to provide a thorough understanding of the claimed subject matter. However, it will be recognized by one of ordinary skill in the art that the claimed subject matter may be practiced without these specific details. In other instances, well known methods, procedures, and systems have not been described in detail as not to unnecessarily obscure aspects of the claimed subject matter.

Some portions of the detailed descriptions which follow are presented in terms of procedures, steps, processes, and other symbolic representations of operations on data on computer memory by one or more processing units. They may take the form of electrical or magnetic signals capable of being stored, transferred, combined, compared, and otherwise manipulated in a computer system.

### INTRODUCTION

Accordingly, embodiments of the claimed subject matter provide a method and system for advertiser monetization. Advertisers bid for preferential placement of their listings in the result set of a search query. Based on the relevancy of an advertiser's listing (sponsored item) within the result set and the advertiser's bid on the listing, the listing may receive a boost in ranking amongst listings of equivalent relevancy. Embodiments of the claimed subject matter and its benefits are further described below.

When a results set responsive to a search query is returned by a search engine, each listing within the results set can be assigned a relevance score. The relevance score may directly reflect an attribute of a listing. When the results set is listings of web pages, the relevance score is usually based upon factors such as the content of a web-page, the trustworthiness of the website, and external factors such as back-links, social media, news, advertising, etc. When the results set is listings of apps, the relevance score may be based on factors such as the number of downloads, the number of installs, the number and quality of ratings and other such metrics.

Sorting the results set by descending value of the relevance score would create a list where the most relevant listing is first or highest in the list. In such sorted results set, any given listing has a higher or equal relevance score or rank to any other listing that is below it in the list.

Suppose that the relevance score of a listing is 66.3 and the relevance score of another listing is 66.2. For most users, the difference in relevance score may be too small for them to perceive that the two listings have different relevancy. The two listings would appear equi-relevant to most users. Equivalence range for relevancy is the maximum difference in relevance score of two items for which the two items are still assumed to be equi-relevant. Equivalence range for a set of criteria is the range within which objects are considered equivalent with regard to the set of criteria. Said another way, if two objects can be considered equivalent with regard to a set of criteria, then their scores, computed based on the set of criteria, are within the equivalence range. Generally, ranking will be perceived to be according to predominant criteria even if items within equivalent ranges of the predominant criteria are reranked according to subordinate criteria.

In some embodiments, equivalence range is specified as a number. In some other embodiments, equivalence range may be specified as a mathematical function implemented in computer code. In some embodiments, equivalence range may be specified as a rule. In some embodiments, determination of equivalence range is based on best guess of an individual or a group of people. In some embodiments, determination of equivalence range is based on experimentation.

### Environment

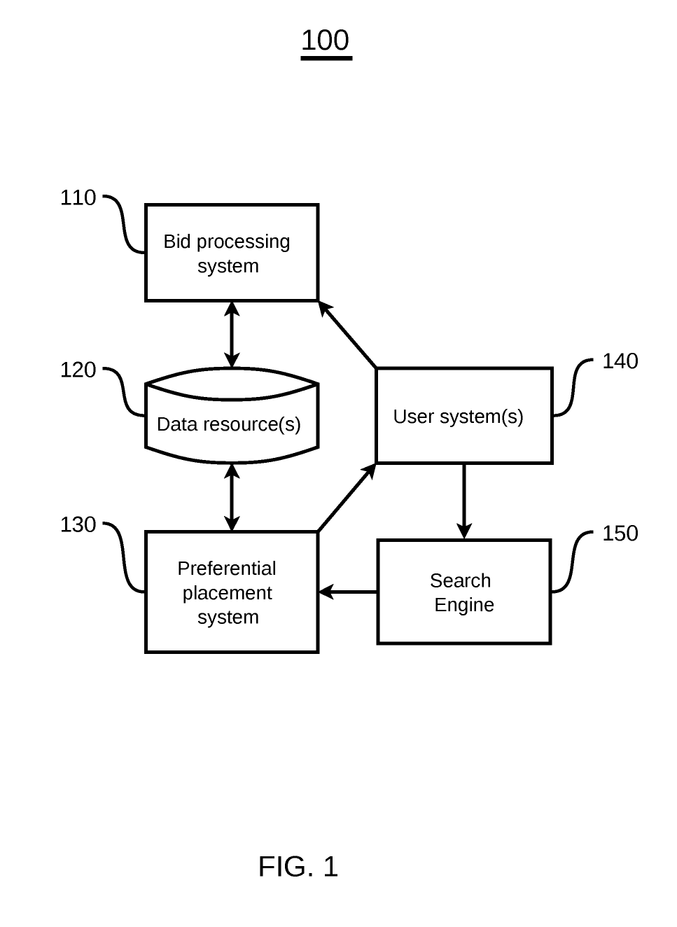

FIG. 1 illustrates an example environment 100 in which the systems and methods discussed herein can be implemented. Environment 100 includes a bid processing system 110. Bid processing system 110 performs various bid management and bid processing activities such as receiving bids and campaign details, displaying performance of various campaigns, activating and deactivating campaigns, and closing a campaign. An advertiser using user system(s) 140 bids for preferred placement and sends paid listing data to bid processing system 110. The paid listing data include a resource identifier that can identify resources of various types and can identify one or more listings in a search results set. The paid listing data also include bid data and may include campaign limits and other campaign details, target keywords, proposed listing title, proposed listing snippet, rules pertaining to listing rank prior to preferential placement, rules pertaining to listing rank after the preferential placement etc. Bid processing system 110 stores or updates paid listing data in data resource(s) 120. Data resource(s) 120 may be a cloud based data resource, networked data resource, a local data resource or a combination using any computer readable media.

A user using user system(s) 140 initiates a search query. A user system(s) 140 may be a desktop computer, a laptop computer or a mobile device such as a smart phone or other computing device. Search engine 150 receives the search query over a network from user system(s) 140 and creates a results set responsive to the search query. Preferential placement system 130 receives the results set from search engine 150 and queries data resource(s) 120 for paid listings data for listings in the results set. Preferential placement system 130 computes a relevance score for each listing. The relevance score may be based on information sent with the search results set by search engine 150. Preferential placement system 130 then sorts the results set such that the listings are ordered predominantly by relevance and subordinately, for equi-relevant listings, by bid. In various embodiments, preferential placement system 130 updates data resource(s) 120 with various details of its activities. In some embodiments, preferential placement system 130 updates listings in the results set with information in the paid listings data.

User system 140 receives the sorted results set over the network and displays the results to the user. To the user, the listings in the search results set appear to be ranked by relevance, with the most relevant listing at the top and the least relevant listing at the bottom. For convenience of the user, the results set may be split into search engine results pages (SERPs). Bid processing system 110 may receive a message or a signal from user system 140 when the user clicks on an advertisement or on any other user action that is being tracked. On receiving this message or signal, bid processing system 110 may save the user activity or update advertisement data in data resource(s) 120.

In some embodiments, preferential placement system 130 delegates the ranking of the results list based on preferential placement to user system(s) 140 by sending executable code with the results set. One example of such executable code is Javascript instructions sent to a browser on user system(s) 140. In some embodiments, the preferential placement system may update the data set used by a search engine to enable the search engine to directly provide results that have preferential placement for paid listings.

In some embodiments, the advertiser is charged only if the paid listing gains at least one place improvement in rank relative to the rank it might have had had it not been a paid listing. For example, if an advertiser's listing rank remains at seventh place whether or not it is treated as a paid listing, then the advertiser is not charged the bid amount. This may happen due to the relevance of the adjoining listings or the bids on the adjoining listings.

In some embodiments, an advertiser may specify that the bid be applied only when the new rank of the paid listing due to preferential placement is better than a specified rank. For example, an advertiser may specify that the bid be applied only if the new rank is among the top three. Then, if the advertiser's listing were not the reach the top three ranks with preferential placement, then the listing would be treated as an unpaid listing and no preferential placement would be provided to it.

### Bidding Process

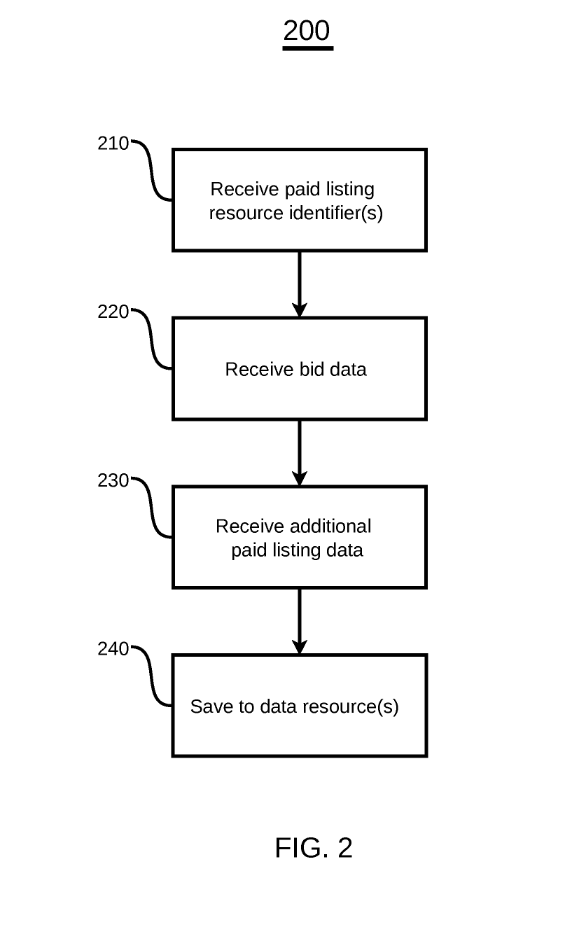

FIG. 2 depicts a flowchart describing a process 200 for bidding for preferential placement of paid listings. Steps 210-240 describe exemplary steps comprising the process 200 in accordance with the various embodiments herein described. Process 200 may be typically available to advertisers who already have an account associated with them. Further, the advertisers' accounts may contain billing information. In various embodiments, if billing information is lacking from the account, the advertiser may be prompted for it after process 200 and the bid goes live only after the billing information is available.

One or more resource identifiers pertaining to paid listing(s) are received from one or more advertisers by an advertisement bid center at step 210. A resource identifier is something that identifies resources of various types and can identify one or more listings in a search results set. The resource identifiers may be URLs or patterns to generate URLs or patterns to match URLs or domain names, web site URL prefixes, app names, media attributes etc. The type of object a resource identifier may identify include audio media, visual media, mixed media, mobile app, web app, product, answer, web page, advertisement, search result, URL, domain name, identifier to an object of an allowed type, search resource, category, keyword, search request, query, and profile

Bid data pertaining to paid listings are received at step 220. The bid data comprises of a bid offer pertaining to resource identifiers received in step 210. Bid offers may be of different types and may include offers of cash or other financial instruments. Types of bid offers also include virtual currencies, points and credits earned by users of a website or a service. The bid may be a fixed cost bid or a performance based bid. Examples of a fixed cost bid includes a cost for a specified time period. Examples for a performance based bid include cost per mille (CPM), cost per click (CPC), cost per view (CPV), and cost per action (CPA). The bid data may also include campaign limits, daily limits, start date or start time, end date or end time.

Additional data pertaining to paid listings are received in step 230. The information received may include a title, text, video, audio, keywords, geographic regions, demographic attributes, device types or other content. Although process 200 shows three distinct steps for receiving information, these steps may be rearranged, or may be combined into one or two steps, or may even be split into further steps.

After receiving paid listings data, comprising of one or more identifiers, bid data, and additional data, in steps 210 through 230, the paid listings data is saved to a data resource in step 240.

Preferential Placement of Paid Listings

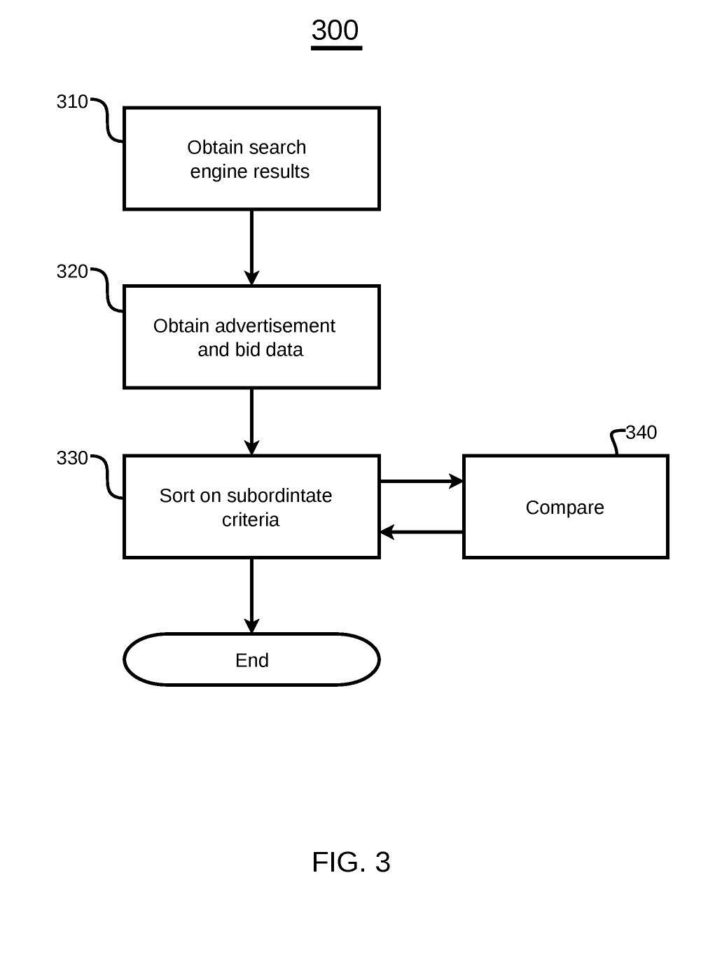

FIG. 3 depicts a flowchart describing a process 300 for preferential placement of paid listings. Steps 310-340 describe exemplary steps comprising the process 300 in accordance with the various embodiments herein described.

In step 310, a search query and a results set responsive to that query is obtained from a search engine. Relevance scores are computed and assigned to listings in the results set if they were not provided by the search engine. Further the results set is ordered by descending order of the relevance score if it was not done by the search engine. In at least one embodiment, the results set is already sorted by some criteria of relevance by the search engine. In some embodiments, only a certain number of the top listings of the results set are processed. For example, only the top 1357 listings from the results set may be considered and any preferential placement of an advertisement would result in a new rank of better than 1357. The benefit includes lower bandwidth costs and saving on processor cycles as some results sets may be extremely large and contain millions of listings.

In step 320, paid listings data pertinent to the listings in the results set are obtained. The paid listings data may be reduced by filtering based on keywords contained in the search query. More paid listings data may be discarded based on the bid data and additional data contained in the paid listings data. For example, paid listings data may be discarded if a campaign has already ended, or if the search query originated outside of the specified geographic region, or if the day of the week is not the one specified in the paid listing's additional data.

In step 330, the paid listings data is incorporated into the results set. In various embodiments, the title and snippet of a matching listings are updated with those provided in the paid listings data. The set is then repeatedly traversed in descending order, taking two listings at a time and invoking step 340 to compare the two listings for preferential placement. If needed, step 330 updates the order of the set based on the result of the step 340. Step 330 continues traversing the set, invoking step 340 and updating the order of the set if needed, till it reaches the end of the set. Step 330 repeats traversal of the set till no updates are made to the order of the set in a given traversal.

In step 340, if the relevance score of the two listings are not within the equivalence range, then the listing with the higher relevance score is ranked higher. If, however, in step 340, the two listings are equi-relevant, that is, they are within the equivalency range, then the listing with the higher bid associated with it is ranked higher. Further, if neither listing has a higher bid than the other, then step 340 ranks the listing with the higher relevance score as higher.

A simplified example is given below to illustrate the working of process 300. The example focuses on steps 330 and 340 where paid listings are re-ranked using preferential placement.

### Example

Consider that the search results set ordered by relevance with the relevance score and bid amount for each listing is (A:95:0, B:81:0, C:79:5, D:75:0, E:74:0, F:70:7). Here the capital letters represent the listings is a results set. The first number following the letters are the relevance score and the second number following the letters are the bid amount. Assume that the equivalence range is 10.

Then the first pass over the results set in step 330 would result in (A:95:0, C:79:5, B:81:0, D:75:0, F:70:7, E:74:0). Item B and C are equivalent in terms of relevancy as the relevance score of B and C are apart by less than the equivalence range of 10. However, item C has a higher bid (5) than item B (0), therefore item C is ranked higher in step 340. Similarly item F ranks higher than item E because they are equi-relevant and item F has a higher bid.

The second pass over the results set in step 330 would result in (A:95:0, C:79:5, B:81:0, F:70:7, D:75:0, E:74:0). Item D and F are equivalent in terms of relevancy but item F has a higher bid so item F is ranked higher in step 340 and the positions of item D and item F are swapped.

There is no change on the next pass over the results set. All paid listings have received their preferential placement and process 300 ends.

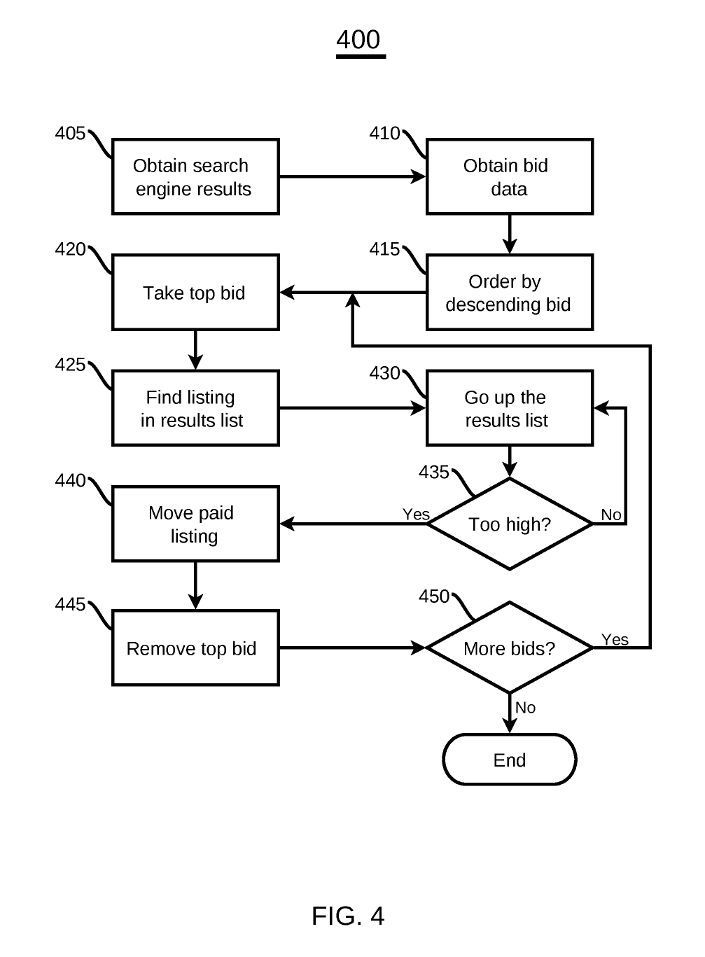

FIG. 4 depicts flowchart describing a process 400 for preferential placement of paid listings. Steps 405-450 describe exemplary steps comprising the process 400 in accordance with the various embodiments herein described.

In step 405, a search query and a results set responsive to that query is obtained from a search engine. Relevance scores are computed and assigned to listings in the results set if they were not done by the search engine. Further the results set is ordered by descending order of the relevance score if it was not done by the search engine. In at least one embodiment, the results set is already sorted by some criteria of relevance by the search engine. In some embodiments, only a certain number of the top listings of the results set are processed. For example, only the top 1357 listings from the results set may be considered and any preferential placement of an advertisement would result in a new rank of better than 1357. The benefit includes lower bandwidth costs and saving on processor cycles as some results sets may be extremely large and contain millions of listings.

In step 410, paid listings data pertinent to the listings in the results set are obtained. Match are made based on the identifiers in the paid listings data. For example, a paid listing data may contain the same URL as present in a search results listing. The paid listings data may be reduced by filtering based on keywords contained in the search query. More paid listings data may be discarded based on the bid data and additional data contained in the paid listings data. For example, paid listings data may be discarded if a campaign has already ended, or if the search query originated outside of the specified geographic region, or if the day of the week is not the one specified in the paid listing's additional data.

In step 415, the paid listings data is ordered by descending order of the bid amount. In step 420, the paid listing data associated with the highest bid is retrieved from the ordered list created in step 415. In step 425, the listing corresponding to the paid listing is identified and retrieved based on the identifier. This is a paid listing and a candidate for preferential placement. In step 430, the result set is traversed up, toward the higher ranked listings, by one position and the listing at that position is retrieved for comparison. In step 435, the paid listing is compared to the listing retrieved in step 430. If the listings are not equi-relevant or if the paid listing has a lower bid, then operation continues with step 440. Else, the operation continues with step 430 where the next higher listing is retrieved for comparison. In step 440, the paid listing is moved to the position just below the last listing retrieved in step 430. Then step 445, removes the top paid listing data from the ordered list created in step 415. In step 450, the ordered list of paid listings data is checked to see if there are any more remaining. If there are more paid listings data remaining, the operation continues with step 420. When there are no more paid listings data remaining in the ordered list created in step 415, the order of the results list has been updated with the preferential placement and the process ends.

As an example, if we consider the same starting results set as used in the example for process 300 we have (A:95:0, B:81:0, C:79:5, D:75:0, E:74:0, F:70:7). If we take the same value of 10 for equivalence range then after going through process 400, the order of the results set at the end is (A:95:0, B:81:0, F:70:7, C:79:5, D:75:0, E:74:0). Notice that the results are different but both satisfy the condition that listings change rank only when they are equivalent based on the predominant criteria.

Processes 300 and 400 have been described with relevance as the predominant criteria and bid amount as the subordinate criteria. The predominant criteria and the subordinate criteria may be different in various embodiments. For example, in some embodiments, the predominant criteria for sorting the results list are based on factors that may include the play time of the media results, the number of views, ratings, quality, price and other attributes of the items in the results list. In some embodiments, the subordinate criteria are based on factors that may include bid amount, performance of the paid listing, advertiser monetization, campaign characteristics, bid time, click trough rate, financial performance, searcher profile, searcher device characteristics etc.

### Exemplary Apparatus

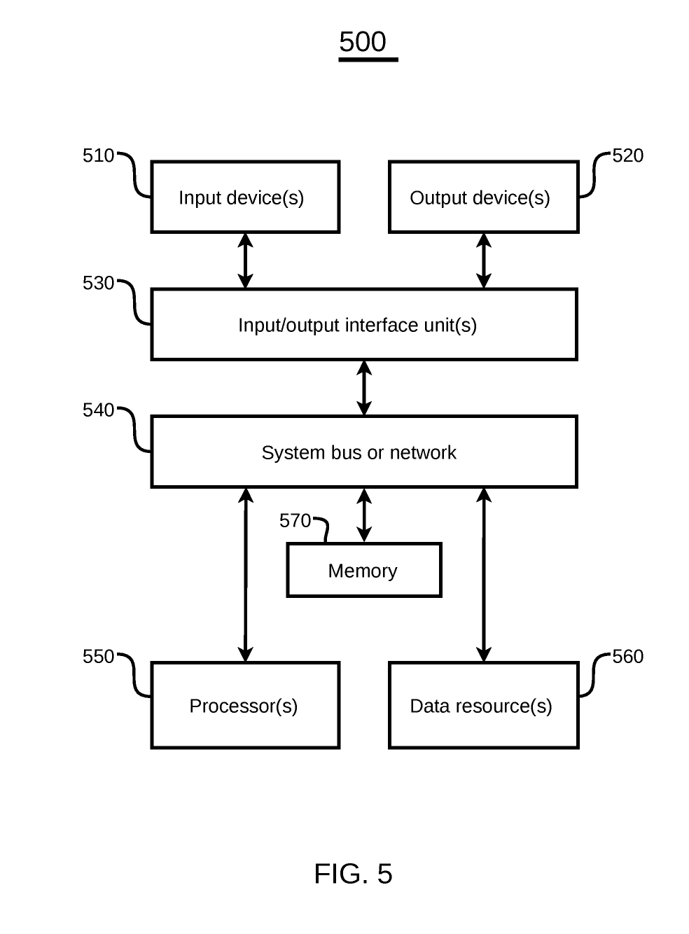

FIG. 5 is a high-level block diagram of apparatus 500 that may be used to effect at least some of the various operations that may be performed in accordance with the claimed subject matter. The apparatus 500 includes, inter alia, processor(s) 550, input/output interface unit(s) 530, data resource(s) 560, memory 570 and system bus or network 540 for facilitating the communication of information among the coupled elements. Input device(s) 510 and output device(s) 520 may be coupled with input/output interface(s) 530.

Processor(s) 550 may execute machine-executable instructions to effect one or more aspects of the claimed subject matter. At least a portion of the machine executable instructions may be stored (temporarily or more permanently) in memory 570 and/or on data resource(s) 560 and/or may be received from an external source via input/output interface unit(s) 530.

In one embodiment, apparatus 500 may be one or more conventional personal computers. In this case, processor(s) 550 may be one or more microprocessors. System bus or network 540 may include a system bus, internet, wide area network, local area network, wireless network etc. Data resource(s) 560 is capable of providing mass storage for the apparatus 500. In one implementation, data resource(s) 560 is a non-transitory computer-readable medium. In various different implementations, data resource(s) 560 can include, for example, a hard disk device, an optical disk device, a storage device that is shared over a network by multiple computing devices (e.g., a cloud storage device), or some other large capacity storage device. Memory 570 stores information within the apparatus 500. In one implementation, the memory 520 is a computer-readable medium. In one implementation, the memory 570 is a volatile memory unit. In another implementation, the memory 570 is a non-volatile memory unit.

A user may enter commands and information into the personal computer through input device(s) 510, such as a keyboard and pointing device (e.g., a mouse) for example. Other input devices such as a microphone, a joystick, a game pad, a satellite dish, a scanner, a touch surface, or the like, may also (or alternatively) be included. These and other input devices are often connected to processor(s) 550 through an appropriate interface 530 coupled to the system bus 540. However, in the context of some operation(s), no input devices, other than those needed to accept queries, and possibly those for system administration and maintenance, are needed.

Output device(s) 520 may include a monitor or other type of display device, which may also be connected to the system bus 540 via an appropriate interface 530. In addition to (or instead of) the monitor, the personal computer may include other (peripheral) output, such as speakers and printers for example.

In various embodiments, apparatus 500 can be a device such as mobile computing devices, mobile communication devices, set-top box television client devices, etc.

Although an example apparatus has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results.

1. A computer-implemented method for preferential placement comprising:
receiving, from an advertiser, a bid for preferential placement of a sponsored item in an ordered list, where said sponsored item belongs in said ordered list and where said ordered list is ordered according to predominant criteria;
saving said bid in a data resource;
determining, by a processor, equi-relevant items in said ordered list that have equivalent relevancy to said sponsored item based on said predominant criteria; and
reordering said equi-relevant items according to subordinate criteria within said ordered list such that said sponsored item precedes at least one item from said equi-relevant items.

2. The method of claim 1, wherein said ordered list is a list of results responsive to a search query and wherein said predominant criteria are based on relevancy to said search query.

3. The method of claim 2, wherein said subordinate criteria are based on monetization potential of said sponsored item.

4. The method of claim 3, further comprising:
receiving, by a processor, said search query; and
displaying, at a client device, said reordered list;

5. The method of claim 3, wherein only the top 1357 items in the said ordered list is evaluated to determine the said equi-relevant items.

6. The method of claim 1, further comprising saving said reordered list in a data resource;

7. The method of claim 1, further comprising:
receiving, by a processor, a request for said ordered list; and
deliver said reordered list in response to said request;

8. A computer system configured to perform a method according to claim 3.
